(19) United States
(12) Patent Application Publication
(10) Pub. No.: US 2026/0166740 A1
(43) Pub. Date: Jun. 18, 2026

(54) SHAFT HOLE ASSEMBLY METHOD AND SYSTEM, AND STORAGE MEDIUM

(71) Applicant: JAKA ROBOTICS CO., LTD., Shanghai (CN)

(72) Inventors: Fan YANG, Shanghai (CN); Xiong XU, Shanghai (CN); Zhenxiang QI, Shanghai (CN); Xiaoli SHI, Shanghai (CN)

(73) Assignee: JAKA ROBOTICS CO., LTD., Shanghai (CN)

(21) Appl. No.: 19/127,059

(22) PCT Filed: Jun. 29, 2023
(86) PCT No.: PCT/CN2023/103561

§ 371 Date: May 2, 2025

(30) Foreign Application Priority Data
Nov. 7, 2022 (CN) 202211385043.7

(51) Int. Cl. B25J 9/16

(52) U.S. Cl. CPC B25J 9/1687; G05B 2219/45064

(57) ABSTRACT

Provided are shaft hole assembly method and system, and storage medium, shaft hole assembly method being applied to shaft hole assembly apparatus including assembly shaft. Method includes: performing plane calibration on assembly shaft within assembly task coordinate system, to obtain position of assembly plane. According to position of assembly plane, controlling assembly shaft to move in first direction of Z axis, to make contact with plane where X axis and Y axis are located; wherein first direction of Z axis is direction of assembly shaft closest to assembly plane. Controlling assembly shaft to traverse along spiral trajectory plane where X axis and Y axis are located, and detecting position of abrupt change to Z axis directional force, to obtain position of assembly hole; and according to position of assembly hole, controlling assembly shaft to move in first direction of Z axis to achieve insertion into hole.

### CROSS-REFERENCE TO RELATED APPLICATIONS

This disclosure claims priority to Chinese patent application No. 202211385043.7, filed with the State Intellectual Property Office of China on Nov. 7, 2022, and entitled “SHAFT HOLE ASSEMBLY METHOD AND SYSTEM, AND STORAGE MEDIUM”, the entire contents of which are incorporated by reference into this disclosure.

### TECHNICAL FIELD

The present disclosure relates to the field of robot assembly, and in particular, to a shaft hole assembly method, system and storage medium.

### BACKGROUND

The shaft hole assembly task is a common task in industrial production. Traditional industrial robots must program the assembly action accurately in advance when performing the shaft hole assembly task. If there is a certain error in the relative position of the shaft hole (such as insufficient calibration accuracy, insufficient positioning accuracy, or disturbance offset, etc.), the shaft hole assembly task will fail, and may even damage the workpiece or the robot itself.

The current shaft hole assembly system has the defect that it is easily disturbed by the outside world or there are unexpected situations during the assembly process, causing the shaft hole assembly task to fail. In addition, the coupling performance between hole positioning and hole inserting in the current shaft hole assembly method is poor, resulting in reduced efficiency of shaft hole assembly.

### SUMMARY

The purpose of the embodiments of the present disclosure is to provide a shaft hole assembly method, device, electronic device and storage medium. The shaft hole assembly method provided by the embodiments of the present disclosure considers hole positioning and hole inserting as a whole process, so that the two stages are well coupled, the problem of operation failure caused by accidents and interference during the operation is solved, and the shaft hole assembly efficiency is improved.

Some embodiments of the present disclosure provide a shaft hole assembly method, which is applied to a shaft hole assembly device for assembling an assembly workpiece having an assembly hole and an assembly plane; the shaft hole assembly device includes an assembly shaft. The shaft hole assembly method may include: performing a plane calibration on the assembly shaft in the assembly task coordinate system to obtain the position of the assembly plane, wherein the plane where the assembly plane is located is the plane where the x-axis and y-axis of the assembly task coordinate system are located; and the direction where the assembly shaft is located is the z-axis of the assembly task coordinate system. According to the position of the assembly plane, the assembly shaft is controlled to move along the first direction of the z-axis to contact the plane where the x-axis and y-axis are located, wherein the first direction of the z-axis is the direction in which the assembly shaft approaches the assembly plane; the assembly shaft is controlled to traverse the plane where the x-axis and y-axis are located with a spiral line trajectory, and the sudden change position of the force in the z-axis direction is detected to obtain the position of the assembly hole; according to the position of the assembly hole, the assembly shaft is controlled to move along the first direction of the z-axis to achieve the hole inserting.

In the above implementation process, the shaft hole assembly method provided in the embodiment of the present disclosure first calibrates the assembly plane; after calibration, the specific position of the assembly plane is obtained, and the hole positioning is achieved through a spiral line trajectory and appropriate force control, and the hole inserting is performed after the hole is searched. Considering the hole positioning and the hole inserting as a whole, the position of the shaft hole is adjusted accordingly at each stage to avoid the failure of the hole inserting due to interference or accident, so as to ensure the success rate of the hole inserting and improve the efficiency of the hole inserting.

In some optional embodiments of the present disclosure, the assembly shaft includes a sensor; the control of the assembly shaft to move along the first direction of the z-axis to contact the plane where the x-axis and y-axis are located according to the position of the assembly plane may comprise: according to the position of the assembly plane, the assembly shaft is controlled to move at a uniform speed at a first speed along the first direction of the z axis. Whether the sensor detects the initial contact force is determined; and if the sensor detects the initial contact force, the initial contact force is changed to the target contact force to contact the plane where the x-axis and the y-axis are located.

In the above implementation process, after obtaining the position of the assembly plane, the assembly shaft approaches the assembly plane at a uniform speed according to the position of the assembly plane; when the assembly shaft contacts the assembly plane, the initial contact force is controlled to be reduced to the target contact force; and the shaft hole assembly method provided by the embodiment of the present disclosure can achieve a stable contact between the assembly shaft and the assembly plane, and can protect the assembly plane from damage.

In some optional embodiments of the present disclosure, changing the initial contact force to the target contact force to contact the plane where the x-axis and the y-axis are located can include: changing the initial contact force to the first contact force at a first convergence speed; determining whether the first contact force is within a preset contact force threshold range; and if the first contact force is within the preset contact force threshold range, changing the first contact force to the target contact force at a second convergence speed, wherein the first convergence speed is greater than the second convergence speed.

In the above implementation process, the shaft hole assembly method provided by the embodiment of the present disclosure reduces the initial contact force to the first contact force at the first convergence speed and reduces the first contact force to the target contact force at the second convergence speed during the process of the assembly shaft contacting the assembly plane, and finally stably contacts the assembly plane with the target contact force; in this process, the first convergence speed is greater than the second convergence speed; it can ensure that the z-direction force of the assembly shaft is controlled in a short time, and the assembly shaft stably contacts the assembly plane while protecting the assembly plane.

In some optional embodiments of the present disclosure, the assembly shaft is controlled to traverse the plane where the x-axis and y-axis are located with a spiral line trajectory, and the sudden change position of the force in the z-axis direction is detected to obtain the position of the assembly hole, which may include: applying a constant pressing force to the assembly shaft in the plane where the x-axis and y-axis are located; and applying a variable force to the assembly shaft in the z-axis direction, wherein the assembly shaft traverses the plane where the x-axis and y-axis are located with a spiral line trajectory according to the constant pressing force and the variable force; and the sudden change position of the force in the z-axis direction is detected by the sensor, and the position of the assembly hole is obtained by the sudden change position.

In the above implementation process, the hole positioning method in the shaft hole assembly method provided in the embodiment of the present disclosure controls the force of the assembly shaft based on the admittance and moves with a spiral line trajectory; and when the position of the assembly shaft or the contact force is detected to have a sudden change, the sudden change position is identified as the position of the assembly hole, thereby determining the position of the assembly hole accurately and efficiently.

In some optional embodiments of the present disclosure, obtaining the position of the assembly hole by the sudden change position may include: at the sudden change position, controlling the assembly shaft to move at a uniform speed at a second speed along the first direction of the z-axis, and obtaining the first movement distance; and determining whether the first movement distance reaches the preset distance, wherein if the first movement distance reaches the preset distance, the hole positioning is determined to be successful, and the position of the assembly hole is obtained.

In the above implementation process, during the hole positioning process, the sudden change position of the force is first found. After the sudden change position of the force is found, it can be understood that the assembly shaft tentatively moves toward the sudden change position; during the movement, the movement distance is monitored, and when the movement distance reaches the preset distance, the sudden change position is identified as the position of the assembly hole. The hole positioning process in the embodiment of the present disclosure is a process of multiple trials; there are multiple determinations in this process, and the hole positioning is determined to be successful only when the conditions are met, which ensures the efficiency of hole positioning.

In some optional embodiments of the present disclosure, the preset distance may be set according to the depth of the assembly hole.

In some optional embodiments of the present disclosure, controlling the assembly shaft to move along the first direction of the z-axis according to the position of the assembly hole to achieve the hole inserting may include: controlling the assembly shaft to move along the first direction of the z-axis according to the position of the assembly hole, and obtaining the second movement distance and the hole inserting force; determining whether the second movement distance reaches the distance threshold and whether the hole inserting force reaches the hole inserting force threshold; and if the second movement distance reaches the distance threshold and the hole inserting force reaches the hole inserting force threshold, then determining that the hole inserting is initially completed.

In the above implementation process, after confirming the position of the assembly hole, the relative position of the assembly hole and the assembly shaft is confirmed; the hole inserting is performed at the best relative position, and during the insertion process, whether the movement distance of the assembly shaft and the hole inserting force reach the threshold respectively is used as the basis for determination, and if both reach the threshold respectively, then the hole inserting is deemed to be initially completed. The dual determination of whether the hole inserting is initially completed by the distance threshold and the hole inserting force threshold avoids the mistaken determination that the initial insertion is successful in the case of accidental slipping.

In some optional embodiments of the present disclosure, if the second movement distance reaches the distance threshold and the hole inserting force reaches the hole inserting force threshold, after determining that the hole inserting is initially completed, the shaft hole assembly method may also include: detecting the position of the assembly shaft, and determining whether the position of the assembly shaft is the standard position, wherein if the position of the assembly shaft is not the standard position, in-hole adjustments are made to complete the hole inserting.

In the above implementation process, the shaft hole assembly method provided by the embodiment of the present disclosure determines the relative position of the hole shaft after the hole inserting is initially completed; if the relative position of the hole shaft is the standard position, then the hole inserting is determined to be successful; if the relative position of the hole shaft is not the standard position, then the assembly shaft needs to be adjusted in the hole. When jamming occurs, the assembly shaft can be adjusted quickly and accurately in the assembly hole to ensure the stability of the hole inserting.

In some optional embodiments of the present disclosure, the standard position may be a position where the relative distance between the center of the assembly shaft and the center of the assembly hole is zero.

In some optional embodiments of the present disclosure, if the position of the assembly shaft is not the standard position, an in-hole adjustment is performed to complete the hole inserting, which may include: obtaining the torque of the assembly shaft by a sensor; obtaining the geometric structure of the assembly hole; determining the rotation axis of the assembly shaft according to the torque and the geometric structure; and rotating the assembly shaft to the standard position with a first preset step length around the rotation axis as a center to complete the hole inserting.

In the above implementation process, the shaft hole assembly method provided in the embodiment of the present disclosure performs in-hole adjustment when the assembly shaft is in the standard position, so that the relative position of the shaft hole is corrected, the relative position of the hole axis is adjusted to the standard position, and the accuracy of the hole inserting is improved.

In some optional embodiments of the present disclosure, the assembly shaft is plane-calibrated in the assembly task coordinate system to obtain the position of the assembly plane, which may include: Step S1: adjusting the position of the assembly shaft with the second preset step length for multiple times until the coordinate signs of the contact point between the assembly shaft and the plane where the x-axis and y-axis are located change; Step S2: reducing the second preset step length by half, and repeating the above step S1 until the second preset step length is less than the preset step length value; and S3: obtaining the orientation of the assembly shaft, and correcting the assembly task coordinate system according to the orientation.

In the above implementation process, the shaft hole assembly method provided in the embodiment of the present disclosure adds an additional plane calibration stage before entering the hole positioning and hole inserting stage, which fully considers that the plane orientation of the x-axis and y-axis given in advance may have errors with the actual orientation. Correcting this error can prevent the situation where the plane where the x-axis and y-axis are located cannot be fitted in the hole positioning stage, and also greatly reduce the pressure of posture adjustment in the hole inserting stage, increase the success rate of the entire assembly task, and reduce the calibration accuracy requirements for the x-axis and y-axis planes in advance.

In some optional embodiments of the present disclosure, adjusting the position of the assembly shaft with a second preset step length for multiple times may include: a probing step: controlling the assembly shaft to move along the first direction of the z-axis to contact the plane where the x-axis and y-axis are located, and recording the sensor reading to obtain the contact force; a coordinate calculation step: calculating the coordinates of the contact point in the assembly task coordinate system according to the contact force; and assembly shaft adjustment step: adjusting the position of the assembly shaft with a second preset step length according to the coordinates of the contact point in the assembly task coordinate system.

In the above implementation process, when the shaft hole assembly method provided by the embodiment of the present disclosure performs in-hole adjustments, the assembly shaft is adjusted with a small step length each time, and the plane calibration is repeated many times. The assembly shaft obtains basic information about the assembly plane before hole positioning, which is benefit to the fit of the assembly shaft and the assembly plane during hole positioning.

Some embodiments of the present disclosure also provide a shaft hole assembly system, which is applied to a shaft hole assembly device; the shaft hole assembly device includes an assembly shaft, and an assembly workpiece having an assembly hole and an assembly plane; the shaft hole assembly system may include: a plane calibration module, a hole positioning module and a hole inserting module. The plane calibration module is configured to perform plane calibration on the assembly shaft in the assembly task coordinate system to obtain the position of the assembly plane, wherein the plane where the assembly plane is located is the plane where the x-axis and y-axis of the assembly task coordinate system are located; and the direction where the assembly shaft is located is the z-axis of the assembly task coordinate system. The hole positioning module is configured to control the assembly shaft to move along the first direction of the z-axis according to the position of the assembly plane to contact the plane where the x-axis and y-axis are located, wherein the first direction of the z-axis is the direction in which the assembly shaft approaches the assembly plane. The hole positioning module is also configured to control the assembly shaft to traverse the plane where the x-axis and y-axis are located with a spiral line trajectory, and detect the sudden change position of the force in the z-axis direction to obtain the position of the assembly hole; and the hole inserting module is configured to control the assembly shaft to move along the first direction of the z-axis according to the position of the assembly hole to achieve the hole inserting.

Some embodiments of the present disclosure also provide an electronic device, which may include a memory and a processor, wherein the memory stores program instructions, and when the processor reads and runs the program instructions, the steps in any of the above implementations are executed.

Some embodiments of the present disclosure also provide a computer-readable storage medium, wherein the readable storage medium stores computer program instructions, and when the computer program instructions are read and run by a processor, the steps in any of the above implementations are executed.

### BRIEF DESCRIPTION OF DRAWINGS

In order to more clearly illustrate the technical solution of the embodiment of the present disclosure, the following is a brief introduction to the drawings required for use in the embodiment of the present disclosure. It should be understood that the following drawings only show certain embodiments of the present disclosure, and therefore should not be regarded as limiting the scope. For those skilled in the art, other relevant drawings can also be obtained based on these drawings without creative work.

FIG. 1 is a flow chart of shaft hole assembly provided in the embodiment of the present disclosure;

FIG. 2 is a flow chart of the assembly shaft contacting the assembly plane provided in the embodiment of the present disclosure;

FIG. 3 is a flow chart of z-direction force control when the assembly shaft contacts the assembly plane provided in the embodiment of the present disclosure;

FIG. 4 is a first hole positioning flow chart provided in the embodiment of the present disclosure;

FIG. 5 is a second hole positioning flow chart provided in the embodiment of the present disclosure;

FIG. 6 is a hole inserting flow chart provided in the embodiment of the present disclosure;

FIG. 7 is a flow chart of in-hole adjustment provided in the embodiment of the present disclosure;

FIG. 8 is a plane calibration flow chart provided in the embodiment of the present disclosure;

FIG. 9 is a force analysis diagram of the assembly shaft provided in the embodiment of the present disclosure;

FIG. 10 is a flow chart of adjusting the position of the assembly shaft provided in the embodiment of the present disclosure;

FIG. 11 is a module schematic diagram of the shaft hole assembly system provided in the embodiment of the present disclosure;

FIG. 12 is a structural schematic diagram of the electronic device provided in the embodiment of the present disclosure.

### DETAILED DESCRIPTION OF EMBODIMENTS

The technical solutions in the embodiments of the present disclosure will be described below in conjunction with the drawings in the embodiments of the present disclosure. For example, the flowcharts and block diagrams in the drawings show the possible architectures, functions and operations of the systems, methods and computer program products according to the multiple embodiments of the present disclosure. In this regard, each block in the flowchart or block diagram may represent a module, a program segment or a part of a code, and the module, program segment or a part of the code contains one or more executable instructions for implementing the specified logical functions. It should also be noted that in some alternative implementations, the functions marked in the block may also occur in an order different from that marked in the drawings. For example, two consecutive blocks can actually be executed substantially in parallel, and they can sometimes be executed in the opposite order, depending on the functions involved. It should also be noted that each block in the block diagram and/or flowchart, and the combination of blocks in the block diagram and/or flowchart, can be implemented with a dedicated hardware-based system that performs the specified functions or actions, or can be implemented with a combination of dedicated hardware and computer instructions. In addition, the functional modules in the various embodiments of the present disclosure can be integrated together to form an independent part, or each module can exist separately, or two or more modules can be integrated to form an independent part.

During the research process, the applicant found that the current shaft hole assembly method or system does not consider hole positioning and hole inserting as a whole; after successful hole positioning, it is converted to a hole inserting operation. During this process, it is very easy to fail to be converted to the hole inserting due to force adjustment or operation interference. If the coupling process between hole positioning and hole inserting is not considered, the shaft hole assembly efficiency will be reduced.

In addition to the above problems, one of the commonly used hole positioning ways in actual operation is to use the shaft hole size information to calculate and acquire the relationship between the force feedback value and the shaft hole offset, so as to make corrections; but this way relies on the precise prior knowledge of the geometric shape and size of the shaft hole in the specific application, and its portability is low.

In some ways, the support vector machine method is used to find holes. This method mainly enables the robot end to search the plane memory broken line where the hole is located, and inputs the real-time force feedback information into the pre-trained SVM classifier to detect the hole positioning end event. However, this support vector machine method has certain requirements for the training data set, and needs to be retrained when the application scenario is changed. Therefore, the portability of this method is not high, and it has high requirements for the data set.

In other ways, hole positioning uses cameras and force sensors for calibration and guidance, but the camera is required to participate; therefore, the peripheral conditions for shaft hole assembly are higher, which increases the cost of shaft hole assembly.

Further, after hole positioning, the hole is inserted. There are also many ways to insert the hole, such as using visual guidance to initially place the assembly shaft into the assembly hole, and then entering the “soft servo” mode at the servo level, so that the robot has a certain degree of obedience to the external force, and completes the adjustment of the assembly shaft in the assembly hole. Further, the z-direction force is controlled in the vertical direction, and the hole is searched through a broken line trajectory in the x and/or y direction. Further, the hole position is determined by the z-direction force; after hole positioning, the hole is inserted, and the posture of the assembly shaft is adjusted based on the feedback force of the hole inserting to complete the hole inserting. However, additional visual assistance is required, and the use of visual assistance will increase additional hardware and may limit the working conditions; it also does not take into account the possibility of accidents during the hole inserting process, such as hole positioning errors, jamming, and the assembly shaft leaving the assembly plane; and the current hole inserting way does not provide a solution when the assembly system accidentally causes the assembly operation to fail.

Based on this, the shaft hole assembly method provided by the embodiment of the present disclosure considers hole positioning and hole inserting as a whole process, and the coupling process between the two; in terms of hole positioning, the hole positioning is realized by plane calibration and spiral line trajectory hole positioning, and visual assistance is not required, which reduces the cost of shaft hole assembly to a certain extent and reduces the requirements for peripheral conditions of shaft hole assembly. After hole positioning, various mutation factors are fully considered and specific solutions are provided to avoid the problem of operation failure due to accidents or external interference.

Referring to FIG. 1, FIG. 1 is a flow chart of shaft hole assembly provided by the embodiment of the present disclosure; the shaft hole assembly method provided by the embodiment of the present disclosure is applied to a shaft hole assembly device; the shaft hole assembly device is mainly used to assemble an assembly workpiece with an assembly hole and an assembly plane; the method may include:

Step S100: plane calibration of the assembly shaft in the assembly task coordinate system is performed to obtain the position of the assembly plane.

In the above step S100, in order to improve assembly efficiency and accuracy, the assembly task coordinate system where the assembly shaft is located is first plane calibrated at the beginning of assembly to accurately obtain the position or orientation of the assembly plane.

It should be noted that the surface where the assembly plane is located is the plane where the x-axis and y-axis of the assembly task coordinate system are located; the plane where the assembly shaft is located is the z-axis of the assembly task coordinate system; the assembly shaft can be moved in the area defined by the x-axis, y-axis and z-axis under the control of the robot to achieve hole positioning, hole inserting and resetting.

Step S101: according to the position of the assembly plane, the assembly shaft is controlled to move along the first direction of the z-axis to contact the plane where the x-axis and y-axis are located.

In the above step S101, after clarifying the specific position or orientation of the assembly plane, the assembly shaft is controlled to move along the first direction of the z-axis to approach and contact the plane where the x-axis and y-axis are located. It should be noted that in the embodiment of the present disclosure, the first direction is the direction close to the assembly plane. Those skilled in the art can understand that in the process of the assembly shaft getting close to and approaching the assembly plane, the z-direction force of the assembly shaft is adjusted and controlled to ensure that the assembly shaft accurately contacts the assembly plane, so that while protecting the assembly workpiece from damage, it contacts the assembly plane smoothly and accurately.

Step S102: the assembly shaft is controlled to traverse the plane where the x-axis and y-axis are located with a spiral line trajectory, and the sudden change position of the force in the z-axis direction is detected to obtain the position of the assembly hole.

In the above step S102, after the assembly shaft contacts the assembly plane, the assembly shaft is controlled to traverse the plane where the x-axis and y-axis are located; more importantly, the embodiment of the present disclosure traverses the plane where the x-axis and y-axis are located with a spiral line as trajectory, and in this process, the sudden change position of the force in the z-axis direction is detected, thereby obtaining the position of the assembly hole. It can be understood by those skilled in the art that if the assembly shaft moves from the plane to the position where the assembly hole is located during the traversal process, the contact force of the assembly shaft will inevitably change suddenly.

As an example, the position where the position of the assembly shaft drops suddenly can also be detected; it can be understood by those skilled in the art that when the assembly shaft moves from the plane to the assembly hole during the traversal process, in addition to the sudden change of the force at the end of the assembly shaft, assembly shaft's position will also change suddenly; the sudden drop of the detection position can also realize hole positioning.

Step S103: the assembly shaft is controlled to move along the first direction of the z-axis according to the position of the assembly hole to realize the hole inserting.

In the above step S103, the hole is successfully searched through step S102. After the hole positioning is completed, preparations before inserting the hole are made according to the position of the assembly hole, and the hole is inserted; during the hole inserting process, the assembly shaft moves along the first direction of the z-axis to insert the hole.

As shown in FIG. 1, the shaft hole assembly method provided in the embodiment of the present disclosure first calibrates the assembly plane; after calibration, the specific position of the assembly plane is obtained, and the hole is searched through a spiral line trajectory and appropriate force control, and the hole is inserted after the hole is searched. Considering the hole positioning and the hole inserting as a whole, the position of the shaft hole is adjusted accordingly at each stage to avoid hole inserting failures caused by interference or accidents, so as to ensure the success rate of the hole inserting and improve the efficiency of the hole inserting.

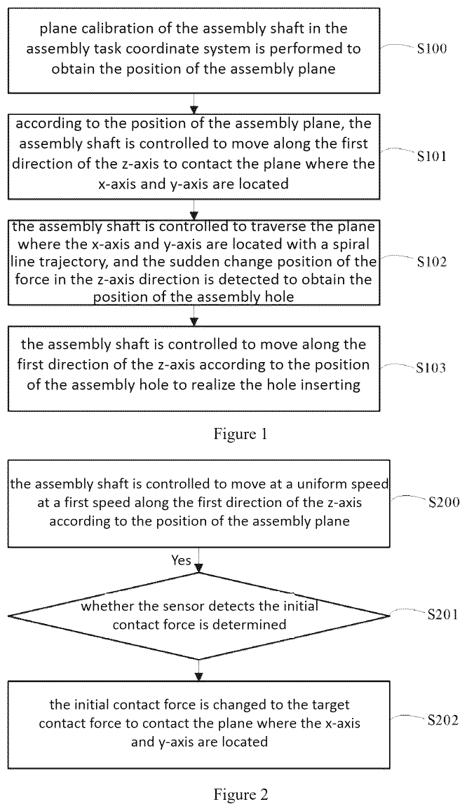

Referring to FIG. 2, FIG. 2 is a flow chart of the assembly shaft contacting the assembly plane provided in the embodiment of the present disclosure; the assembly shaft provided in the embodiment of the present disclosure has a sensor; the sensor can detect the contact force of the assembly shaft, and exemplarily, the sensor can be a torque sensor, a pressure sensor, etc. that can realize the contact force perception of the assembly shaft. The method may include:

Step S200: the assembly shaft is controlled to move at a uniform speed at a first speed along the first direction of the z-axis according to the position of the assembly plane.

In the above step S200, after the position of the assembly plane is determined, the assembly shaft is controlled to move along the first direction of the z-axis, that is, the direction close to the assembly plane, to achieve contact between the assembly shaft and the assembly plane. In this process, the assembly shaft approaches the assembly plane at a uniform speed at a first speed; it should be noted that the approaching the assembly plane at a uniform speed at a first speed mentioned in the embodiment of the present disclosure is not necessarily an absolute uniform speed; in some cases, the speed at the beginning of the movement and the speed at the time of just contact are not required to be exactly the same as the first speed; or during the entire movement, the fluctuation within 5% around the first speed can be considered as uniform motion.

Step S201: whether the sensor detects the initial contact force is determined.

In the above step S201, in the moving process of the assembly shaft approaching the assembly plane, it is detected in real time whether the contact force of the assembly shaft changes or whether the contact force is detected; it can be understood by those skilled in the art that when the assembly shaft approaches the assembly plane until it contacts the assembly plane, the assembly shaft and the assembly plane will generate an initial contact force.

Step S202: if the sensor detects the initial contact force, the initial contact force is changed to the target contact force to contact the plane where the x-axis and y-axis are located.

In the above step S202, if the sensor detects the initial contact force, it indicates that the assembly shaft has contacted the assembly plane. It can be understood by those skilled in the art that at the moment of the assembly shaft contacting the assembly plane, the assembly shaft has a certain speed, and then an initial contact force will be generated on the assembly plane; in order to protect the assembly plane, the contact force of the assembly shaft needs to be quickly adjusted from the initial contact force to the target contact force, so as to complete the contact between the assembly shaft and the assembly plane.

For example, the assembly shaft is controlled to approach the assembly plane at a uniform speed at a first speed. When the contact force is detected, that is, the assembly shaft has contacted the assembly plane, if the target contact force is FO (the size of the target contact force varies with the assembly task), the initial contact force is converged to the target contact force FO.

As can be seen from FIG. 2, after obtaining the position of the assembly plane according to the embodiment of the present disclosure, the assembly shaft approaches the assembly plane at a uniform speed according to the position of the assembly plane; when the assembly shaft contacts the assembly plane, the initial contact force is controlled to change to the target contact force; the shaft hole assembly method provided by the embodiment of the present disclosure can realize the assembly shaft to be in stable contact with the assembly plane, and can protect the assembly plane from damage during the shaft hole assembly process.

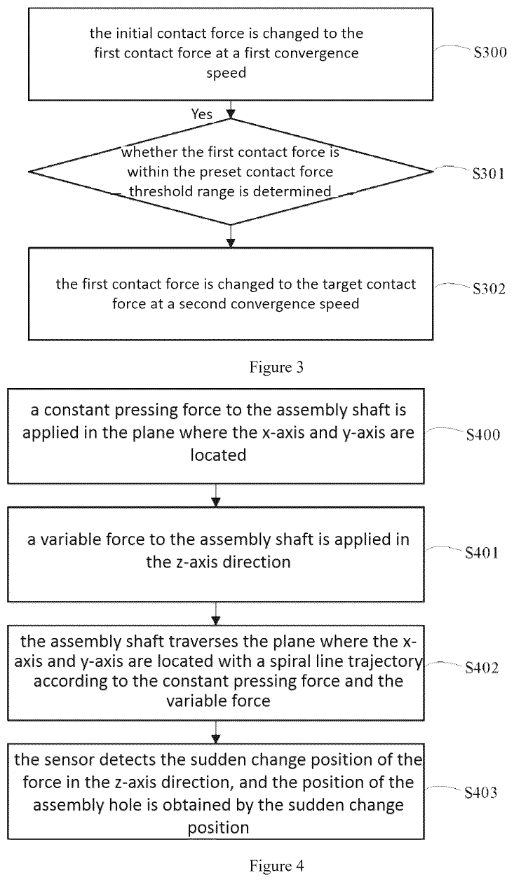

Referring to FIG. 3, FIG. 3 is a flow chart of z-direction force control when the assembly shaft provided in the embodiment of the present disclosure contacts the assembly plane; the method may include:

Step S300: the initial contact force is changed to the first contact force at a first convergence speed.

In the above step S300, at the moment of the assembly shaft contacting the assembly plane, in order to protect the assembly plane, the initial contact force is changed to the first contact force at a first convergence speed.

Step S301: whether the first contact force is within the preset contact force threshold range is determined.

In the above step S301, during the change of the initial contact force, the contact force of the assembly shaft is detected by a sensor; the change of the initial contact force is determined with the preset contact force threshold range. Exemplarily, the minimum threshold in the preset contact force threshold range is greater than 85% of the target contact force FO.

Step S302: if the first contact force is within the preset contact force threshold range, the first contact force is changed to the target contact force at a second convergence speed.

In the above step S302, when the first temporary contact force is within the preset contact force threshold range, the contact force is continuously reduced at the second convergence speed until it is reduced to the target contact force.

Exemplarily, the assembly shaft approaches the assembly plane at a uniform speed at the first speed. When the contact force is detected, that is, the assembly shaft has contacted the assembly plane, if the target contact force is F0, the initial contact force is converged to the target contact force F0. The initial contact force is changed to the first contact force, and the first contact force can be greater than 85% of the target contact force. Further, the speed is continuously reduced at the second convergence speed greater than the first convergence speed; the first contact force is converged to the vicinity of the contact force or after a period of time (such as 5s), it is determined that the assembly shaft is in contact with the plane where the x-axis and y-axis are located.

It should be noted that in the above implementation process, the first convergence speed is greater than the second convergence speed; that is, the process of the initial contact force changing to the first temporary contact force is a rapid change process; and the process of the first temporary contact force changing to the target contact force is a relatively slow change process.

As shown in FIG. 3, in the process of the assembly shaft contacting the assembly plane, the shaft hole assembly method provided by the embodiment of the present disclosure changes the initial contact force to the first contact force at the first convergence speed, changes the first contact force to the target contact force at the second convergence speed, and finally stably contacts the assembly plane with the target contact force; in this process, the first convergence speed is greater than the second convergence speed; it can ensure that the z-direction force of the assembly shaft can be controlled in a short time, and the assembly shaft stably contacts the assembly plane while the assembly plane is protected.

Here, the relationship between the initial contact force, the first contact force and the target contact force in the above process is explained. The force when the assembly shaft just contacts the assembly plane is the initial contact force; after contact, the force changes rapidly and changes to the first contact force; further, the first contact force changes to the target contact force. The change from the initial contact force to the first contact force is usually a monotonically increasing process, and the first contact force is greater than the target contact force; the change from the first contact force to the target contact force can be irregular, but the target contact force is greater than the first contact force.

Exemplarily, the target contact force is 0.5N and monotonically changes to the first contact force which is 8.5N, and the first contact force 8.5N then changes to the target contact force 10N; it is worth noting that the process of the first contact force 8.5N changing to the target contact force 10N can be monotonically increasing; it can also be irregularly changing, such as changing from 8.5N to 12N, and then decreasing from 12N to 10N.

Referring to FIG. 4, FIG. 4 is a first hole positioning flow chart provided by an embodiment of the present disclosure, the method may include:

Step S400: a constant pressing force to the assembly shaft is applied in the plane where the x-axis and y-axis are located.

Step S401: a variable force to the assembly shaft is applied in the z-axis direction.

In the above steps S400-S401, a constant pressing force is applied to the assembly shaft in the plane where the x-axis and y-axis are located, and a variable force is applied in the z-axis direction. The control of the assembly shaft force adopts the method of admittance control.

Those skilled in the art can understand that the admittance controller is a type of controller that is widely and commonly used in the field of robots. The principle of admittance control is: the contact force between the robot and the outside world obtained by measurement or external force estimation by force sensors and the reference force planned by the upper layer is used as the input of the admittance controller, and the input force command is converted into the position command of the robot by the admittance controller and sent to the corresponding joint position actuator.

It should be noted that the control of the assembly shaft in the embodiment of the present disclosure adopts time-division control based on admittance control; specifically, a contact force threshold is set, and the first speed is used to move at a constant speed in a position control manner before contact; after the assembly shaft contacts the assembly plane, the assembly shaft is controlled by the admittance control mode; it should be noted that during the movement of the assembly shaft, the contact force of the assembly shaft is allowed to have a threshold range, and within the threshold range, the assembly shaft is deemed to be stationary at the current position, and when it starts to move in a spiral line trajectory, the admittance parameter is adjusted accordingly to speed up the response speed.

Step S402: the assembly shaft traverses the plane where the x-axis and y-axis are located with a spiral line trajectory according to the constant pressing force and the variable force.

In the above step S402, a constant pressing force is applied to the plane where the x-axis and the y-axis is located, the assembly shaft is located in the plane; a variable force is applied in the z-axis direction; at the same time, the plane where the x-axis and y-axis are located is traversed with a spiral line trajectory. It can be understood by those skilled in the art that the embodiment of the present disclosure adopts a spiral line trajectory hole positioning method, which is highly mature and robust; it will not be disturbed by unstable factors such as friction; and compared with the broken line, the hole positioning by spiral line trajectory has higher efficiency.

Step S403: the sensor detects the sudden change position of the force in the z-axis direction, and the position of the assembly hole is obtained by the sudden change position.

In the above step S403, while the assembly shaft traverses the plane where the x-axis and y-axis are located in a spiral line manner, the sensor detects the contact force of the assembly shaft. If the contact force suddenly changes, the sudden change position can be identified as the location of the assembly hole.

In some embodiments, the position change of the assembly shaft can also be detected. It can be understood by those skilled in the art that when the assembly shaft traverses the plane where the x-axis and y-axis are located with a spiral line trajectory, and it moves from the assembly plane to the assembly hole, the position of the assembly shaft will suddenly change; that is, when a sudden change in the position of the assembly shaft is detected, the sudden change position can be identified as the location of the assembly hole.

As shown in FIG. 4, the hole positioning method in the shaft hole assembly method provided in the embodiment of the present disclosure controls the force of the assembly shaft based on the admittance and moves with a spiral line trajectory; when the position of the assembly shaft or the contact force is detected to be suddenly changed, the sudden change position is identified as the position of the assembly hole, thereby determining the position of the assembly hole accurately and efficiently.

Referring to FIG. 5, FIG. 5 is a second hole positioning flow chart provided in the embodiment of the present disclosure, the method may include:

Step S500: at the sudden change position, the assembly shaft is controlled to move at a uniform speed at a second speed along the first direction of the z-axis, and the first movement distance is obtained.

In the above step S500, after the sudden change position is found, the assembly shaft is controlled to move at a uniform speed at a second speed along the first direction of the z-axis, and the first movement distance is obtained. The second speed can be a lower speed, such as 1mm/s.

Step S501: whether the first movement distance reaches the preset distance is determined.

Step S502: if the first movement distance reaches the preset distance, it is determined that the hole positioning is successful, and the position of the assembly hole is obtained.

In the above steps S501-S502, it is determined whether the first movement distance reaches the preset distance. When the first movement distance reaches the preset distance, it is determined that the hole positioning is successful; and then the position of the assembly hole is obtained. It should be noted that the preset distance is set according to the depth of the assembly hole in the assembly task, and the general preset distance is 95% of the assembly hole.

It can be seen from FIG. 5 that in the hole positioning process, the sudden change position of the force is first found. After the sudden change position of the force is found, it can be understood that the assembly shaft tentatively moves to the sudden change position; during the movement, the movement distance is monitored. When the movement distance reaches the preset distance, the sudden change position is determined to be the position where the assembly hole is located. The hole positioning process in the embodiment of the present disclosure is a multiple trial process; there are multiple judgments in this process, and the hole positioning is determined to be successful only when the conditions are met, which ensures the efficiency of the hole positioning.

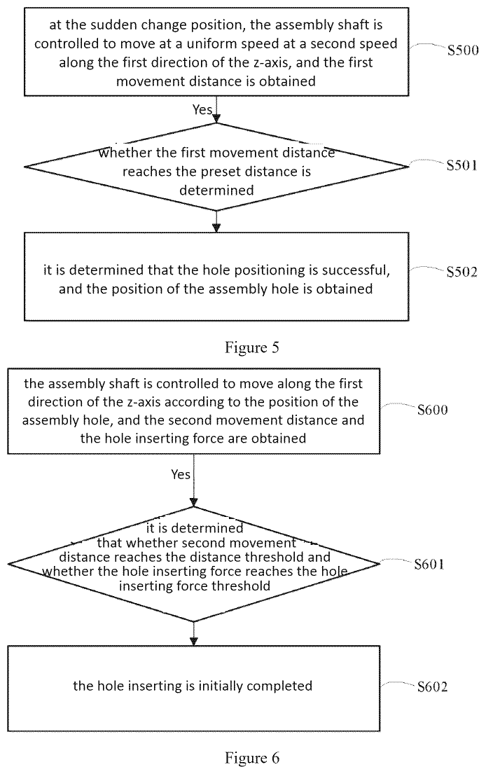

Referring to FIG. 6, FIG. 6 is a hole inserting flow chart provided in the embodiment of the present disclosure, the method may include:

Step S600: the assembly shaft is controlled to move along the first direction of the z-axis according to the position of the assembly hole, and the second movement distance and the hole inserting force are obtained.

In the above step S600, the assembly shaft is controlled to move along the first direction of the z-axis according to the position of the assembly hole; the distance of this movement and the hole inserting force are obtained.

Step S601: it is determined that whether the second movement distance reaches the distance threshold and whether the hole inserting force reaches the hole inserting force threshold.

Step S602: if the second movement distance reaches the distance threshold and the hole inserting force reaches the hole inserting force threshold, it is determined that the hole inserting is initially completed.

In the above steps S601-S602, during the movement, the changes of the second movement distance and the hole inserting force are determined; it can be understood by those skilled in the art that when the assembly shaft contacts the bottom of the assembly hole, the movement distance and the hole inserting force of the assembly shaft will change; when the movement distance and the hole inserting force are within their respective threshold ranges, it can be determined that the hole inserting is initially completed.

As shown in FIG. 6, after confirming the position of the assembly hole, the relative position of the assembly hole and the assembly shaft is confirmed; the hole inserting is performed at the optimal relative position, and during the hole inserting process, whether the movement distance and the hole inserting force of the assembly shaft reach the thresholds respectively is used as the basis for determination. If both reach the thresholds respectively, it is determined that the hole inserting is initially completed. By using the distance threshold and the hole inserting force threshold to determine twice whether the hole inserting is initially completed, it is avoided that the initial insertion is wrongly determined to be successful in the case of accidental slipping.

In an optional embodiment, after the second movement distance reaches the distance threshold and the hole inserting force reaches the hole inserting force threshold, it is determined that the hole inserting is initially completed. The shaft hole assembly method can also include detecting the position of the assembly shaft and determining whether the position of the assembly shaft is a standard position; if the position of the assembly shaft is not a standard position, the adjustments are made in the hole to complete the hole inserting.

Exemplarily, after the initial hole inserting is completed, the position of the assembly shaft and the position of the assembly hole are detected; it is determined whether the position of the assembly shaft is a standard position. If it is a standard position, the hole inserting is directly determined to be successful; if it is not a standard position, it is necessary to further adjust the position of the assembly shaft in the hole to adjust the position of the assembly shaft to the standard position. It should be noted that the standard position is the position where the relative distance between the center of the assembly shaft and the center of the assembly hole is zero; that is, the position where the assembly shaft and the assembly hole are completely aligned in the z-axis direction.

It can be seen that the shaft hole assembly method provided in the embodiment of the present disclosure determines the relative position of the hole-shaft after the initial completion of the hole inserting; if the relative position of the hole-shaft is the standard position, then the hole inserting is deemed successful; if the relative position of the hole-shaft is not the standard position, then the assembly shaft needs to be adjusted in the hole. When jamming occurs, the assembly shaft can be quickly and accurately adjusted in the assembly hole to ensure the stability of the hole inserting.

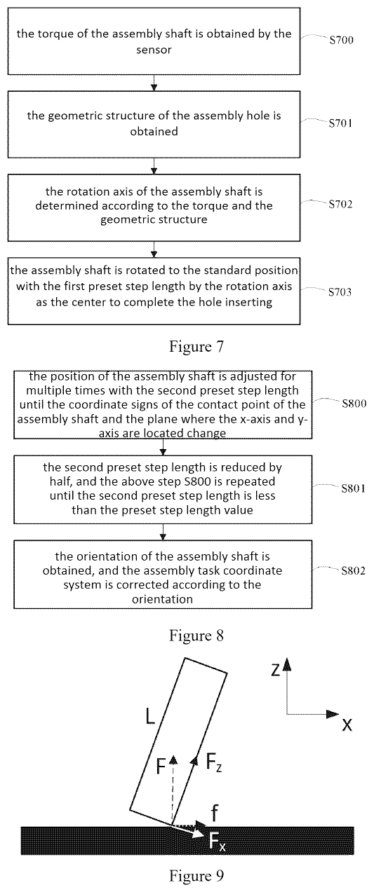

Referring to FIG. 7, FIG. 7 is a flow chart of the in-hole adjustment provided in the embodiment of the present disclosure, the method may include:

Step S700: the torque of the assembly shaft is obtained by the sensor.

In the above step S700, the torque of the assembly shaft is obtained by the sensor. It can be understood by those skilled in the art that when the direction line of the force acting on the object does not pass through the center of gravity of the object, an eccentric force is subjected for the object, and the effect of the eccentric force is to cause the object to rotate and move along the force direction. The rotation generated is called the torque of the force on the object. Then, when the relative position of the shaft-hole is not the standard position, the assembly shaft will generate a corresponding torque; the analysis and correction of the position of the assembly shaft can be achieved through the analysis of the torque.

Step S701: the geometric structure of the assembly hole is obtained.

Step S702: the rotation axis of the assembly shaft is determined according to the torque and the geometric structure.

In the above steps S701-S702, the rotation axis of the assembly shaft is determined according to the torque and the geometric structure. The torque can be directly read by the sensor.

Step S703: the assembly shaft is rotated to the standard position with the first preset step length by the rotation axis as the center to complete the hole inserting.

In the above step S703, after determining the rotation axis, the assembly shaft is rotated to the standard position with the first preset step length by the rotation axis as the center. After the rotation axis rotates to the standard position, it can be determined that the hole inserting is successful. It should be noted that the first preset step length can have different values in different shaft hole assembly tasks, generally 1°.

For example, the unit vector of the xy torque reading of the force sensor is used as the rotation axis direction, and half of the completed insertion depth is used as the rotation center. The posture is rotated in equal steps (such as 1°) until the torque disappears and the normal hole inserting state is restored.

Those skilled in the art can understand that the above process is generally called “flexible”, which includes posture flexible scheme and six-dimensional flexible scheme. In the embodiment of the present disclosure, the full six-dimensional flexible scheme is used in the process of hole inserting; and the admittance control is adopted in the position. The fixed step length adjustment is adopted in the posture, which has better performance than the scheme of only adopting the posture flexibility, and has better stability than the scheme of adopting six-dimensional full admittance control.

As can be seen from FIG. 7, the shaft hole assembly method provided in the embodiment of the present disclosure performs in-hole adjustment when the assembly shaft is not in the standard position, so that the relative position of the shaft hole is corrected, the relative position of the hole and the shaft is adjusted to the standard position, and the accuracy of the hole inserting is improved.

Referring to FIG. 8, FIG. 8 is a plane calibration flow chart provided by an embodiment of the present disclosure; and referring to FIG. 9, FIG. 9 is a force analysis diagram of the assembly shaft provided by an embodiment of the present disclosure, the method may include:
before starting the plane calibration, the coordinates of the contact point are calculated to obtain the coordinates of the contact point, as shown in FIG. 9, wherein Fz is the z-direction force, Fx is the x-direction force, F is the resultant force on the assembly shaft, and f is the friction resistance between the assembly shaft and the assembly hole.

Exemplarily, the coordinates of the contact point in the assembly task coordinate system are estimated, x=−(Ty-Fx*L)/Fz; y=(Tx+Fy*L)/Fz, wherein Tx, Ty are the torque readings of the sensor in the x-axis direction and the y-axis direction; Fx, Fy, Fz are the force readings in the x-axis direction, the y-axis direction, and the z-axis direction; L is the length of the shaft; thereby determining the coordinates (x, y) of the contact point.

Step S800: the position of the assembly shaft is adjusted for multiple times with the second preset step length until the coordinate signs of the contact point of the assembly shaft and the plane where the x-axis and y-axis are located change.

In the above step S800, the position of the assembly shaft is adjusted multiple times with the second preset step length until the coordinate sign of the contact point between the assembly shaft and the plane where the x-axis and the y-axis are located changes. It should be noted that the second preset step length can be determined according to the assembly task, and is generally 1°. For example, if the last calculated coordinate x is a negative number, the assembly shaft is rotated 1° around the positive direction of the y-axis; if the coordinate y is a positive number, the assembly shaft is rotated 1° around the positive direction of the x-axis until the coordinate sign changes.

Step S801: the second preset step length is reduced by half, and the above step S800 is repeated until the second preset step length is less than the preset step length value.

In the above step S801, the second preset step length is reduced by half, and the above step S800 is repeated until the second preset step length is less than the preset step length value. Exemplarily, when x changes from negative to positive, the adjustment step length in the y direction, that is, the angle of each rotation, is adjusted from the previous 1° to 0.5°; when y changes from negative to positive, the adjustment step length in the x direction, that is, the angle of each rotation, is adjusted from the previous 1° to 0.5°. The coordinates are adjusted to a step length less than 0.3°, and the posture of the current assembly shaft is recorded as the plane direction.

Step S802: the orientation of the assembly shaft is obtained, and the assembly task coordinate system is corrected according to the orientation.

In the above step S802, the orientation of the assembly shaft is obtained, and the assembly task coordinate system is corrected according to the orientation; the normal of the assembly shaft coincides with the z-axis direction of the assembly coordinate system.

It can be seen from FIGS. 8 and 9 that the shaft hole assembly method provided in the embodiment of the present disclosure adds an additional plane calibration stage before entering the hole positioning and hole inserting stage, which fully takes into account that the plane orientation of the x-axis and y-axis given in advance may have errors with the actual orientation. This error corrected can prevent the situation where the plane where the x-axis and y-axis are located cannot be fitted in the hole positioning stage, and can also greatly reduce the pressure of posture adjustment in the hole inserting stage, increase the success rate of the entire assembly task, and reduce the calibration accuracy requirements for the x-axis and y-axis planes in advance.

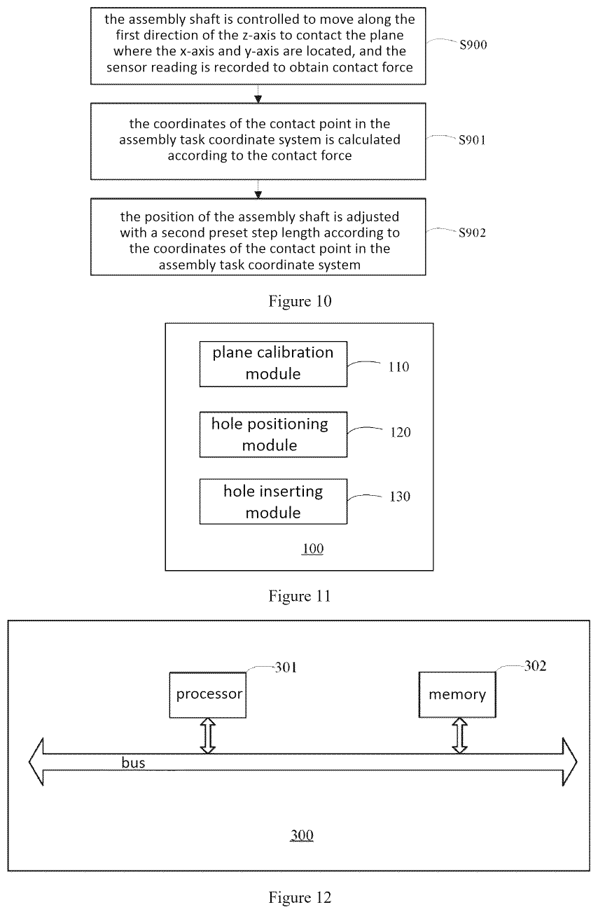

Referring to FIG. 10, FIG. 10 is a flow chart of adjusting the position of the assembly shaft provided in the embodiment of the present disclosure; and referring to FIG. 9, the method may include:

Step S900: the assembly shaft is controlled to move along the first direction of the z-axis to contact the plane where the x-axis and y-axis are located, and the sensor reading is recorded to obtain the contact force.

Step S901: the coordinates of the contact point in the assembly task coordinate system is calculated according to the contact force.

In the above steps S900-S901, the assembly shaft is controlled to move along the first direction of the z-axis to contact the plane where the x-axis and y-axis are located, and the sensor reading is recorded to obtain the contact force F; the coordinates of the contact point in the assembly task coordinate system are calculated according to the contact force. Exemplarily, the coordinates of the contact point in the assembly task coordinate system are estimated, x=−(Ty-Fx*L)/Fz; y=(Tx+Fy*L)/Fz, where Tx, Ty are the torque readings of the sensor in the x-axis direction and the y-axis direction; Fx, Fy, Fz are the force readings in the x-axis direction, the y-axis direction, and the z-axis direction; L is the length of the shaft, so that the coordinates (x, y) of the contact point are determined.

Step S902: the position of the assembly shaft is adjusted with a second preset step length according to the coordinates of the contact point in the assembly task coordinate system.

In the above step S902, the position of the assembly shaft is adjusted with a second preset step length according to the coordinates of the contact point in the assembly task coordinate system, wherein the second preset step length is generally 1°. Exemplarily, if the last calculated coordinate x is a negative number, the assembly shaft is rotated 1° around the positive direction of the y-axis; if the coordinate y is a positive number, the assembly shaft is rotated 1° around the positive direction of the x-axis.

As can be seen from FIG. 10, when the shaft hole assembly method provided in the embodiment of the present disclosure is adjusted in the hole, the assembly shaft is adjusted with a small step length each time, and the plane calibration is repeated many times. The assembly shaft obtains basic information about the assembly plane before searching the hole, which is benefit to the fit of the assembly shaft and the assembly plane during the hole positioning process.

In some embodiments, the relative position of the shaft hole and the position of the assembly shaft are monitored during the entire assembly process. If the assembly shaft has been aligned with the hole position in the process of approaching the assembly plane, then the preparation before the hole inserting is directly prepared to prepare for the hole inserting.

In some embodiments, if it is detected that the assembly shaft accidentally leaves the x-axis and y-axis planes during the spiral hole positioning process, the assembly shaft is controlled to return to the process of contacting the assembly plane and re-contact the assembly plane.

In some embodiments, if it is detected that the assembly shaft is accidentally jammed, the assembly shaft is flexible in the x-axis and y-axis directions to get rid of the jamming. If the trial before the hole inserting is not successful, it indicates that the hole positioning is wrong, so the assembly shaft is controlled to return to the spiral hole positioning process to continue to search the hole.

In some embodiments, if before preparing the hole inserting, the extrusion force in the x-axis and y-axis directions is detected, and the assembly shaft is not in the exact center of the hole or is in chamfer contact, the x-y direction force is adjusted to be flexible in the x-axis and y-axis directions to further move the shaft to the center of the hole.

If jamming occurs during the hole inserting, the x-y direction force is adjusted to be flexible in the x-axis and y-axis directions; or the posture in the hole is fine-tuned to restore the hole inserting, and if it still cannot be solved, it is directly pulled out to avoid further damage.

Referring to FIG. 11, FIG. 11 is a module schematic diagram of the shaft hole assembly system provided in an embodiment of the present disclosure; the shaft hole assembly system 100 includes: a plane calibration module 110, a hole positioning module 120 and a hole inserting module 130. The shaft hole assembly system 100 is applied to a shaft hole assembly device; the shaft hole assembly device includes an assembly shaft, and an assembly workpiece having an assembly hole and an assembly plane.

The plane calibration module 110 is configured to perform plane calibration on the assembly shaft in the assembly task coordinate system to obtain the position of the assembly plane, wherein the plane where the assembly plane is located is the plane where the x-axis and y-axis of the assembly task coordinate system are located; and the direction where the assembly shaft is located is the z-axis of the assembly task coordinate system.

The hole positioning module 120 is configured to control the assembly shaft to move along the first direction of the z-axis according to the position of the assembly plane to contact the plane where the x-axis and y-axis are located, wherein the first direction of the z-axis is the direction in which the assembly shaft approaches the assembly plane.

The hole positioning module 120 is also configured to control the assembly shaft to traverse the plane where the x-axis and y-axis are located with a spiral line trajectory, and detect the position of the sudden change of the force in the z-axis direction to obtain the position of the assembly hole.

The hole inserting module 130 is configured to control the assembly shaft to move along the first direction of the z-axis according to the position of the assembly hole to achieve the hole inserting.

In an optional embodiment, the assembly shaft includes a sensor; the hole positioning module 120 controls the assembly shaft to move along the first direction of the z-axis according to the position of the assembly plane to contact the plane where the x-axis and the y-axis are located, which may include: the hole positioning module 120 controls the assembly shaft to move at a uniform speed at a first speed along the first direction of the z-axis according to the position of the assembly plane; it is determined that whether the sensor detects the initial contact force; if the sensor detects the initial contact force, the hole positioning module 120 changes the initial contact force to the target contact force to contact the plane where the x-axis and the y-axis are located.

In an optional embodiment, the hole positioning module 120 reduces the initial contact force to the target contact force to contact the plane where the x-axis and the y-axis are located, which may include: the hole positioning module 120 changes the initial contact force to the first contact force at a first convergence speed; it is determined that whether the first contact force is within a preset contact force threshold range; if the first contact force is within the preset contact force threshold range, the hole positioning module 120 changes the first contact force to the target contact force at a second convergence speed, wherein the first convergence speed is greater than the second convergence speed.

In an optional embodiment, the hole positioning module 120 controls the assembly shaft to traverse the plane where the x-axis and y-axis are located with a spiral line trajectory, and detects the sudden change position of the force in the z-axis direction to obtain the position of the assembly hole, which may include: the hole positioning module 120 applies a constant pressing force to the assembly shaft in the plane where the x-axis and y-axis are located; applies a variable force to the assembly shaft in the z-axis direction; the assembly shaft traverses the plane where the x-axis and y-axis are located with a spiral line trajectory according to the constant pressing force and the variable force; the sensor detects the sudden change position of the force in the z-axis direction, and the position of the assembly hole is obtained by the sudden change position.

In an optional embodiment, the hole positioning module 120 obtains the position of the assembly hole by the sudden change position, which may include: at the sudden change position, the hole positioning module 120 controls the assembly shaft to move at a uniform speed at a second speed along the first direction of the z-axis, and obtains the first movement distance; it is determined whether the first movement distance reaches the preset distance; if the first movement distance reaches the preset distance, it is determined that the hole positioning is successful, and the position of the assembly hole is obtained.

In an optional embodiment, the hole inserting module 130 controls the assembly shaft to move along the first direction of the z-axis according to the position of the assembly hole to realize the hole inserting, which may include: the hole inserting module 130 controls the assembly shaft to move along the first direction of the z-axis according to the position of the assembly hole, and obtains the second movement distance and the hole inserting force; the hole inserting module 130 determines whether the second movement distance reaches the distance threshold and whether the hole inserting force reaches the hole inserting force threshold; if the second movement distance reaches the distance threshold and the hole inserting force reaches the hole inserting force threshold, it is determined that the hole inserting is initially completed.

In an optional embodiment, if the second movement distance reaches the distance threshold and the hole inserting force reaches the hole inserting force threshold, it is determined that the hole inserting is initially completed. After that, the shaft hole assembly method may also include: the hole inserting module 130 detects the position of the assembly shaft and determines whether the position of the assembly shaft is a standard position; if the position of the assembly shaft is not a standard position, an in-hole adjustment is performed to complete the hole inserting.

In an optional embodiment, if the position of the assembly shaft is not the standard position, the hole inserting module 130 performs in-hole adjustment to complete the hole inserting, which may include: the torque of the assembly shaft is obtained by a sensor; the geometric structure of the assembly hole is obtained; it is determined that the rotation axis of the assembly shaft according to the torque and the geometric structure; the hole inserting module 130 rotates the assembly shaft to the standard position with a first preset step length around the rotation axis as a center to complete the hole inserting.

In an optional embodiment, the hole inserting module 130 performs a plane calibration on the assembly shaft in the assembly task coordinate system to obtain the position of the assembly plane, which may include: Step S1: the hole inserting module 130 adjusts the position of the assembly shaft with a second preset step length for multiple times until the coordinate signs of the contact point between the assembly shaft and the plane where the x-axis and the y-axis are located change. Step S2: the hole inserting module 130 reduces the second preset step length by half, and repeats the above step S1 until the second preset step length is less than the preset step length value. Step S3: the hole inserting module 130 obtains the orientation of the assembly shaft and corrects the assembly task coordinate system according to the orientation.

In an optional embodiment, the hole inserting module 130 adjusts the position of the assembly shaft for multiple times with a second preset step length, which may include: a probing step: the hole inserting module 130 controls the assembly shaft to move along the first direction of the z-axis to contact the plane where the x-axis and the y-axis are located, and records the sensor reading to obtain the contact force; a coordinate calculation step: the hole inserting module 130 calculates the coordinates of the contact point in the assembly task coordinate system according to the contact force; and an assembly shaft adjustment step: the hole inserting module 130 adjusts the position of the assembly shaft with a second preset step length according to the coordinates of the contact point in the assembly task coordinate system.

Referring to FIG. 12, FIG. 12 is a structural schematic diagram of an electronic device provided in an embodiment of the present disclosure. An electronic device 300 provided in an embodiment of the present disclosure may include: a processor 301 and a memory 302, the memory 302 stores machine-readable instructions executable by the processor 301, and the machine-readable instructions are executed by the processor 301 to execute the above method.

Based on the same inventive concept, an embodiment of the present disclosure also provides a computer-readable storage medium, in which computer program instructions are stored, and when the computer program instructions are read and run by a processor, the steps in any of the above implementations are executed.

Computer-readable storage medium can be Random Access Memory (RAM), Read Only Memory (ROM), Programmable Read-Only Memory (PROM), Erasable Programmable Read-Only Memory (EPROM), Electric Erasable Programmable Read-Only Memory (EEPROM) and other medium that can store program codes. The storage medium is used to store the program, and the processor executes the program after receiving the execution instruction. The method executed by the electronic terminal defined by the process disclosed in any embodiment of the present disclosure can be applied to the processor or implemented by the processor.

In the embodiments provided in the present disclosure, it should be understood that the disclosed device and method can be implemented in other ways. The device embodiments described above are only schematic. For example, the division of the unit is only a logical function division. There may be other division methods in actual implementation. For example, multiple units or components can be combined or integrated into another system, or some features can be ignored or not executed. Another point is that the mutual coupling or direct coupling or communication connection shown or discussed may be an indirect coupling or communication connection through some communication interfaces, devices or units, which may be electrical, mechanical or other forms.

In addition, the unit described as a separate component may or may not be physically separated, and the component displayed as a unit may or may not be a physical unit, that is, it may be located in one place, or it may be distributed on multiple network units. Some or all of the units may be selected according to actual needs to achieve the purpose of the scheme of this embodiment.

Furthermore, the functional modules in each embodiment of the present disclosure may be integrated together to form an independent part, or each module may exist separately, or two or more modules may be integrated to form an independent part.

It may be replaced and may be implemented in whole or in part by software, hardware, firmware or any combination thereof. When implemented by software, it may be implemented in whole or in part in the form of a computer program product. The computer program product includes one or more computer instructions. When the computer program instructions are loaded and executed on a computer, the process or function described in the embodiment of the present disclosure is generated in whole or in part.

The computer may be a general-purpose computer, a special-purpose computer, a computer network, or other programmable device. The computer instructions may be stored in a computer-readable storage medium or transmitted from one computer-readable storage medium to another computer-readable storage medium, for example, the computer instructions may be transmitted from one website, computer, server or data center to another website, computer, server or data center by wired (e.g., coaxial cable, optical fiber, digital subscriber line (DSL)) or wireless (e.g., infrared, wireless, microwave, etc.) means.

In this document, relational terms such as first and second, etc. are used only to distinguish one entity or operation from another entity or operation, and do not necessarily require or imply any such actual relationship or order between these entities or operations. Moreover, the terms “include”, “comprise” or any other variation thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “include . . . ” do not exclude the existence of other identical elements in the process, method, article or device including the elements.

The above description is only an embodiment of the present disclosure and is not intended to limit the scope of protection of the present disclosure. For those skilled in the art, the present disclosure may have various changes and variations. Any modifications, equivalent replacements, improvements, etc. made within the spirit and principles of the present disclosure shall be included in the scope of protection of the present disclosure.

### INDUSTRIAL APPLICABILITY

The present disclosure provides a shaft hole assembly method, system and storage medium, which is applied to a shaft hole assembly device; the shaft hole assembly device includes an assembly shaft. The method includes: performing a plane calibration on the assembly shaft in the assembly task coordinate system to obtain the position of the assembly plane. According to the position of the assembly plane, the assembly shaft is controlled to move along the first direction of the z-axis to contact the plane where the x-axis and the y-axis are located, wherein the first direction of the z-axis is the direction in which the assembly shaft approaches the assembly plane. The assembly shaft is controlled to traverse the plane where the x-axis and the y-axis are located with a spiral line trajectory, and the sudden change position of the force in the z-axis direction is detected to obtain the position of the assembly hole; according to the position of the assembly hole, the assembly shaft is controlled to move along the first direction of the z-axis to realize the hole inserting. The shaft hole assembly method provided in the embodiment of the present disclosure considers the hole positioning and the hole inserting as a whole process, so that the two stages are well coupled; it solves the problem of operation failure caused by accidents and interference during the operation process, and improves the efficiency of shaft hole assembly.

In addition, it can be understood that the shaft hole assembly method and shaft hole assembly system of the present disclosure are reproducible and can be used in a variety of industrial applications. For example, the shaft hole assembly method and shaft hole assembly system of the present disclosure can be used in any device that needs to improve the efficiency of shaft hole assembly.

1. A shaft hole assembly method, wherein the shaft hole assembly method is applied to a shaft hole assembly device for assembling an assembly workpiece having an assembly hole and an assembly plane; the shaft hole assembly device comprises an assembly shaft; the shaft hole assembly method comprises:
performing plane calibration of the assembly shaft in an assembly task coordinate system to obtain a position of the assembly plane, wherein a plane where the assembly plane is located is a plane where an x-axis and a y-axis of the assembly task coordinate system are located; and a direction where the assembly shaft is located is a z-axis of the assembly task coordinate system;
controlling the assembly shaft to move along a first direction of the z-axis to contact the plane where the x-axis and y-axis are located according to the position of the assembly plane, wherein the first direction of the z-axis is a direction where the assembly shaft approaches the assembly plane;
controlling the assembly shaft to traverse the plane where the x-axis and y-axis are located with a spiral line trajectory, and detecting a sudden change position of a force in a z-axis direction to obtain a position of the assembly hole; and
controlling the assembly shaft to move along the first direction of the z-axis according to the position of the assembly hole to achieve a hole inserting.

2. The shaft hole assembly method according to claim 1, wherein the assembly shaft comprises a sensor; the controlling the assembly shaft to move along a first direction of the z-axis to contact the plane where the x-axis and y-axis are located according to the position of the assembly plane comprises:
controlling the assembly shaft to move at a uniform speed at a first speed along the first direction of the z-axis according to the position of the assembly plane;
determining whether the sensor detects an initial contact force; and
when the sensor detects the initial contact force, changing the initial contact force to a target contact force to contact the plane where the x-axis and y-axis are located.

3. The shaft hole assembly method according to claim 2, wherein the changing the initial contact force to a target contact force to contact the plane where the x-axis and the y-axis are located comprises:
changing the initial contact force to a first contact force at a first convergence speed;
determining whether the first contact force is within a preset contact force threshold range; and
when the first contact force is within the preset contact force threshold range, changing the first contact force to the target contact force at a second convergence speed,
wherein the first convergence speed is greater than the second convergence speed.

4. The shaft hole assembly method according to claim 2, wherein the controlling the assembly shaft to traverse the plane where the x-axis and y-axis are located with a spiral line trajectory, and detecting a sudden change position of a force in a z-axis direction to obtain a position of the assembly hole comprises:
applying a constant pressing force to the assembly shaft in the plane where the x-axis and y-axis are located; and
applying a variable force to the assembly shaft in the z-axis direction, wherein the assembly shaft traverses the plane where the x-axis and y-axis are located with the spiral line trajectory according to the constant pressing force and the variable force; and
a sudden change position of the force in the z-axis direction is detected by the sensor, and the position of the assembly hole is obtained by the sudden change position.

5. The shaft hole assembly method according to claim 4, wherein the position of the assembly hole being obtained by the sudden change position comprises:
at the sudden change position, controlling the assembly shaft to move at a uniform speed at a second speed along the first direction of the z-axis, and obtaining a first movement distance;
determining whether the first movement distance reaches a preset distance; and
when the first movement distance reaches the preset distance, determining that a hole positioning is successful, and the position of the assembly hole is obtained.

6. The shaft hole assembly method according to claim 5, wherein the preset distance is set according to a depth of the assembly hole.

7. The shaft hole assembly method according to claim 2, wherein the controlling the assembly shaft to move along the first direction of the Z-axis according to the position of the assembly hole to achieve a hole inserting comprises:
controlling the assembly shaft to move along the first direction of the z-axis according to the position of the assembly hole, and obtaining a second movement distance and a hole inserting force;
determining whether the second movement distance reaches a distance threshold and whether the hole inserting force reaches the hole inserting force threshold, wherein
when the second movement distance reaches the distance threshold and the hole inserting force reaches the hole inserting force threshold, then it is determined that the hole inserting is initially completed.

8. The shaft hole assembly method according to claim 7, wherein when the second movement distance reaches the distance threshold and the hole inserting force reaches the hole inserting force threshold, then it is determined that the hole inserting is initially completed, after that, the shaft hole assembly method further comprises:
detecting the position of the assembly shaft and determining whether the position of the assembly shaft is a standard position, wherein
when the position of the assembly shaft is not a standard position, in-hole adjustments are made to complete the hole inserting.

9. The shaft hole assembly method according to claim 8, wherein the standard position is a position where a relative distance between a center of the assembly shaft and a center of the assembly hole is zero.

10. The shaft hole assembly method according to claim 8, wherein when the position of the assembly shaft is not a standard position, in-hole adjustments are made to complete the hole inserting, comprising:
obtaining a torque of the assembly shaft by the sensor;
obtaining a geometric structure of the assembly hole;
determining a rotation axis of the assembly shaft according to the torque and the geometric structure;
rotating the assembly shaft to the standard position with a first preset step length around the rotation axis as a center to complete the hole inserting.

11. The shaft hole assembly method according to claim 2, wherein the performing plane calibration of the assembly shaft in an assembly task coordinate system to obtain a position of the assembly plane comprises:
Step S1: adjusting the position of the assembly shaft for multiple times with a second preset step length until coordinate signs of a contact point between the assembly shaft and the plane where the x-axis and y-axis are located change;
Step S2: reducing the second preset step length by half, repeating the above Step S1 until the second preset step length is less than a preset step length value; and
Step S3: obtaining an orientation of the assembly shaft, and correcting the assembly task coordinate system according to the orientation.

12. The shaft hole assembly method according to claim 11, wherein the adjusting the position of the assembly shaft for multiple times with a second preset step length comprises:
a step of probing: controlling the assembly shaft to move along the first direction of the z-axis until the assembly shaft contacts the plane where the x-axis and the y-axis are located, and recording a sensor reading to obtain the contact force;
a step of coordinate calculation: calculating coordinates of the contact point in the assembly task coordinate system according to the contact force; and
a step of adjusting the assembly shaft: adjusting the position of the assembly shaft with the second preset step length according to the coordinates of the contact point in the assembly task coordinate system.

13. A shaft hole assembly system, wherein the shaft hole assembly system is applied to a shaft hole assembly device; the shaft hole assembly device comprises an assembly shaft, and an assembly workpiece having an assembly hole and an assembly plane; the shaft hole assembly system comprises: a plane calibration module, a hole positioning module and a hole inserting module;
the plane calibration module is configured to perform plane calibration on the assembly shaft in an assembly task coordinate system to obtain a position of the assembly plane, wherein a plane where the assembly plane is located is a plane where an x-axis and a y-axis of the assembly task coordinate system are located; and a direction where the assembly shaft is located is a z-axis of the assembly task coordinate system;
the hole positioning module is configured to control the assembly shaft to move along a first direction of the z-axis according to the position of the assembly plane, so as to contact the plane where the x-axis and y-axis are located, wherein the first direction of the z-axis is a direction in which the assembly shaft approaches the assembly plane;
the hole positioning module is further configured to control the assembly shaft to traverse the plane where the x-axis and y-axis are located with a spiral line trajectory, and detect a sudden change position of a force in a z-axis direction to obtain a position of the assembly hole; and
the hole inserting module is configured to control the assembly shaft to move along the first direction of the z-axis according to the position of the assembly hole, so as to achieve the hole inserting.

14. A computer-readable storage medium, wherein the computer-readable storage medium stores computer program instructions, and when the computer program instructions are executed by a processor, the steps in the shaft hole assembly method according to claim 1 are executed.

15. The shaft hole assembly method according to claim 3, wherein the controlling the assembly shaft to traverse the plane where the x-axis and y-axis are located with a spiral line trajectory, and detecting a sudden change position of a force in a z-axis direction to obtain a position of the assembly hole comprises:
applying a constant pressing force to the assembly shaft in the plane where the x-axis and y-axis are located; and
applying a variable force to the assembly shaft in the z-axis direction, wherein
the assembly shaft traverses the plane where the x-axis and y-axis are located with the spiral line trajectory according to the constant pressing force and the variable force; and
a sudden change position of the force in the z-axis direction is detected by the sensor, and the position of the assembly hole is obtained by the sudden change position.

16. The shaft hole assembly method according to claim 3, wherein the controlling the assembly shaft to move along the first direction of the z-axis according to the position of the assembly hole to achieve a hole inserting comprises:
controlling the assembly shaft to move along the first direction of the z-axis according to the position of the assembly hole, and obtaining a second movement distance and a hole inserting force;
determining whether the second movement distance reaches a distance threshold and whether the hole inserting force reaches the hole inserting force threshold, wherein
when the second movement distance reaches the distance threshold and the hole inserting force reaches the hole inserting force threshold, then it is determined that the hole inserting is initially completed.

17. The shaft hole assembly method according to claim 4, wherein the controlling the assembly shaft to move along the first direction of the z-axis according to the position of the assembly hole to achieve a hole inserting comprises:
controlling the assembly shaft to move along the first direction of the z-axis according to the position of the assembly hole, and obtaining a second movement distance and a hole inserting force;
determining whether the second movement distance reaches a distance threshold and whether the hole inserting force reaches the hole inserting force threshold, wherein
when the second movement distance reaches the distance threshold and the hole inserting force reaches the hole inserting force threshold, then it is determined that the hole inserting is initially completed.

18. The shaft hole assembly method according to claim 9, wherein when the position of the assembly shaft is not a standard position, in-hole adjustments are made to complete the hole inserting, comprising:
obtaining a torque of the assembly shaft by the sensor;
obtaining a geometric structure of the assembly hole;
determining a rotation axis of the assembly shaft according to the torque and the geometric structure;
rotating the assembly shaft to the standard position with a first preset step length around the rotation axis as a center to complete the hole inserting.

19. The shaft hole assembly method according to claim 3, wherein the performing plane calibration of the assembly shaft in an assembly task coordinate system to obtain a position of the assembly plane comprises:
Step S1: adjusting the position of the assembly shaft for multiple times with a second preset step length until coordinate signs of a contact point between the assembly shaft and the plane where the x-axis and y-axis are located change;
Step S2: reducing the second preset step length by half, repeating the above Step S1 until the second preset step length is less than a preset step length value; and
Step S3: obtaining an orientation of the assembly shaft, and correcting the assembly task coordinate system according to the orientation.

20. The shaft hole assembly method according to claim 4, wherein the performing plane calibration of the assembly shaft in an assembly task coordinate system to obtain a position of the assembly plane comprises:
Step S1: adjusting the position of the assembly shaft for multiple times with a second preset step length until coordinate signs of a contact point between the assembly shaft and the plane where the x-axis and y-axis are located change;
Step S2: reducing the second preset step length by half, repeating the above Step S1 until the second preset step length is less than a preset step length value; and
Step S3: obtaining an orientation of the assembly shaft, and correcting the assembly task coordinate system according to the orientation.
